(19) United States
(12) Patent Application Publication
(10) Pub. No.: US 2007/0018411 A1
(43) Pub. Date: Jan. 25, 2007

(54) Co-rotating shaft seal system

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, JP

(21) Appl. No.: 11/187,710

(22) Filed: Jul. 25, 2005

(51) Int. Cl. F16J 15/00

(52) U.S. Cl. 277/500

(57) ABSTRACT

The invention is directed to develop for the higher sealing capability of a rotating shaft than that of the conventional oil seal by means of making use of pushing back force caused by compressed onto both sides of internal and external surfaces of the rubber cylinder designed to rotate together with revolution of the rotating shaft fixed thereon tightly with smaller diameter of the internal cylinder while compressing onto the surface of the stationary inside wall of the opening of the casing with the specific preparation to prevent from moving rotating position such as tapered internal cylinder and lips on outside surface of the external cylinder.

### FIELD OF THE INVENTION

The present invention is generally directed to developing for the rotating shaft sealing system applied to the device designed to prevent the fluid from leakage with high sealing capacity and simple design capable of reducing manufacturing as well as running costs for devices.

### BACKGROUND OF THE INVENTION

1. Field of the Invention

This invention relates to the technology to solve the problem of rotating shaft seal which have been suffered from leakage of the fluid applied to the various kinds of the devices in industrial uses caused due to the irrational mechanism, in particular, under the high pressure in the chamber of the devices.

2. Description of the Prior Art

The prior art of the rotating shaft seal have depended on the method to seal the fluid through around the surface of the rotating shaft by means of clutching the surface of the rotating shaft with rubber lip kept in stationary condition, thus being liable for causing leakage by the centrifugal force which work to bend the rubber tip laterally at a right angle produced in proportion to the rotating speed of the shaft. As is the case with the strong centrifugal force, the compressed fluid charged inside the chamber cause to leak under high pressure as well.

### SAMMARY OF THE INVENTION

The present invention is generally directed to develop for a high performance of the rotating shaft seal system designed to use an elastic cylinder of which inside diameter of the internal space formed is made for being smaller than that of the shaft so that both surfaces of the internal cylinder formed in taper and the rotating shaft may be tightly fixed on each other in co-rotating operation thus preventing from leaking the fluid through intervals, in the opposite side, outside diameter of the external cylinder is designed for larger than that of an opening of the casing thus allowing to seal any fluid through intervals between both surfaces of the stationary wall of the internal opening of the casing and the rotating external elastic cylinder. Therefore, the rotating shaft seal system of this invention depend on the sealing method for the leakage of the fluid to take advantage of pushing back force caused by means of compressing on the elastic cylinder on both inside and outside simultaneously in engagement where the surface of the rotating elastic cylinder is prepared to take form of sharpen rubber lips on the crest portion to decrease friction loss as much as possible.

### BRIEF DISCRIPTION OF THE DRAWINGS

FIG. 1: The cross sectional side view of a co-rotating shaft sealing system of this invention as an example of the invention.

FIG. 2: The cross sectional side view of a co-rotating shaft seal system in engagement as an example of this invention.

### DETAILED DESCRIPTION OF THE INVENTION

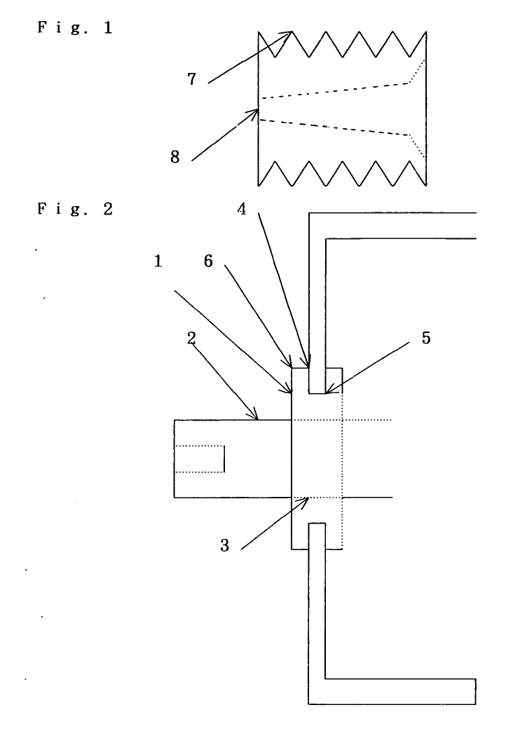

As shown FIG. 1, the present invention is related to the co-rotating shaft seal system 1 which is composed of a rubber cylinder 1 with tapered internal cylinder 8 to be fixed on the surface 3 of a rotating shaft 2 to co-rotate and with a rolling rubber cylinder of which surface 6 is prepared with sharpen rubber on the crest portion 7 alternatively with slit rubber 4 to make gap 5 between compressed and flat 6 external surface of the cylinder to prevent the position of the rotating rubber cylinder 1 in rotating operation. The sharpen rubber on the crest portion 7 is prepared to decrease friction loss, otherwise larger space to contact with both surfaces would produce more resistance in rotating operation. In addition, the tapered internal cylinder 8 is designed to assist easy engaging operation smoothly and to prevent from moving back the rotating position on the surface of the rotating shaft 2 in rotating operation.

One of the remarkable features of this invention is designed to take advantage of casing of the device to make avail of pushing back force caused by compression onto the surface of the wall of the opening 5, thus enabling to secure tight sealing in view of the fact that the strong seal force is available for making use of pushing back force after compression onto the stationary surface of the hardware.

1. A co-rotating shaft seal system depend on the sealing method by use of an elastic cylinder which is designed to rotate together with the rotating shaft to be fixed on its surface with smaller inside diameter to be enlarged in fabrication than that of the rotating shaft, on the other hand, the outside diameter of the external surface of the cylinder is made for larger than that of an internal wall of an opening of a casing thus sealing fluid flowing through the intervals between both surfaces of the external cylinder and the internal wall of the opening.

2. A sealing method for a rotating shaft depend on the method to make use of the force of pushing back on compressing elastic material tightly on both sides of the external and internal surfaces simultaneously in engagement, thus capable of sealing the leakage of any fluids.

3. An elastic cylinder to be used for a rotating shaft seal is composed of a tapered internal cylinder to make easy adopting operation, at the same time, to prevent the sealing position on the surface of rotating shaft from moving, on the other hand, the external surface of the cylinder is slit to make a stopper where pushing back force make rubber wall slide along the slit surface between before and behind of the sealing portion compressed with heavy pressure preventing from moving the position as if the rotating cylinder is surrounded with the wall, and or prepared with sharpening rubber in the form of lips on the crest portion in order to decrease friction loss in rotating operation.
